(19) United States
(12) Patent Application Publication
(10) Pub. No.: US 2022/0217823 A1
(43) Pub. Date: Jul. 7, 2022

(54) AVERAGE INDUCTOR CURRENT REGULATION FOR POWER CONVERTERS

(71) Applicant: SEMICONDUCTOR COMPONENTS INDUSTRIES, LLC, Phoenix, AZ (US)

(72) Inventor: Dominique ROMEO, Montauban (FR)

(73) Assignee: SEMICONDUCTOR COMPONENTS INDUSTRIES, LLC, Phoenix, AZ (US)

(21) Appl. No.: 17/248,039

(22) Filed: Jan. 6, 2021

(51) Int. Cl. H05B 45/3725; H05B 47/14

(52) U.S. Cl. CPC H05B 45/3725; H05B 47/14

(57) ABSTRACT

Average inductor current regulation for power converters. At least one example embodiment is a method including: sampling a drain-to-source voltage of a power transistor during a switching period of the driving LED, the sampling creates a sampled drain-to-source voltage; creating an error signal based on a difference between the sampled drain-to-source voltage and a setpoint drain-to-source voltage, the setpoint drain-to-source voltage proportional to a setpoint average current through the LED; and changing an on-time of a charge mode of an inductor based on the error signal.

### CROSS-REFERENCE TO RELATED APPLICATIONS

Not applicable.

### BACKGROUND

Light-emitting diodes (LEDs) are increasingly popular for lighting systems for a variety of reasons. The reasons may include greater light produced per unit of power supplied to the LED (compared, for example, to incandescent bulbs), and controllability of the LEDs. The increased popularity of LEDs is also true for the automotive industry.

At least in the context of the automotive industry, LEDs are controlled by controlling average current through the LEDs. Related-art control techniques directly measure current through the LEDs by way of a shunt resistor. However, even using a low value resistance as the shunt resistor, use of a shunt resistor results in sensing losses and thus lower overall efficiency of the LED driving circuit.

Any method or system that reduces sensing losses would provide a competitive advantage in the marketplace.

### BRIEF DESCRIPTION OF THE DRAWINGS

For a detailed description of example embodiments, reference will now be made to the accompanying drawings in which:

FIG. 1 shows a block diagram of a LED module in accordance with at least some embodiments;

FIG. 2 shows a block diagram of a driver circuit in accordance with at least some embodiments;

FIG. 3 shows a block diagram of a reference controller in accordance with at least some embodiments;

FIG. 4 shows a block diagram of a sample controller in accordance with at least some embodiments;

FIG. 5 shows a block diagram of an average current controller in accordance with at least some embodiments;

FIG. 6 shows a timing diagram in accordance with at least some embodiments;

FIG. 7 shows a block diagram of a sample controller in accordance with at least some embodiments; and

FIG. 8 shows a method in accordance with at least some embodiments.

### DEFINITIONS

Various terms are used to refer to particular system components. Different companies may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct connection. Thus, if a first device couples to a second device, that connection may be through a direct connection or through an indirect connection via other devices and connections.

The terms “input” and “output” when used as nouns refer to connections (e.g., electrical, software), and shall not be read as verbs requiring action. For example, a timer circuit may define a clock output. The example timer circuit may create or drive a clock signal on the clock output. In systems implemented directly in hardware (e.g., on a semiconductor substrate), the “inputs” and “outputs” define electrical connections. In systems implemented in software, the “inputs” and “outputs” define parameters read by or written by, respectively, the instructions implementing the function.

“Assert” shall mean changing the state of a Boolean signal. Boolean signals may be asserted high or with a higher voltage, and Boolean signals may be asserted low or with a lower voltage, at the discretion of the circuit designer. Similarly, “de-assert” shall mean changing the state of the Boolean signal to a voltage level opposite the asserted state.

“Controller” shall mean, alone or in combination, individual circuit components, an application specific integrated circuit (ASIC), a microcontroller with controlling software, a digital signal processor (DSP), a processor with controlling software, a programmable logic device (PLD), or a field programmable gate array (FPGA), configured to read inputs and drive outputs responsive to the inputs.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Various example embodiments are directed to methods and systems of average inductor current regulation for power converters. More particularly, various example embodiments are directed to switch-mode power converters (SMPS) driving one or more light-emitting diodes (LEDs) using average current control. More particularly still, various example embodiments are directed to driving one or more LEDs with an average current without directly sensing the current to the LEDs. Moreover, the example driver circuit and related methods do not know and need not be provided the value of the inductance of the SMPS used to drive the LEDs—the driver circuit and related methods are agnostic to the inductance. The specification first turns to a high-level system overview to orient the reader.

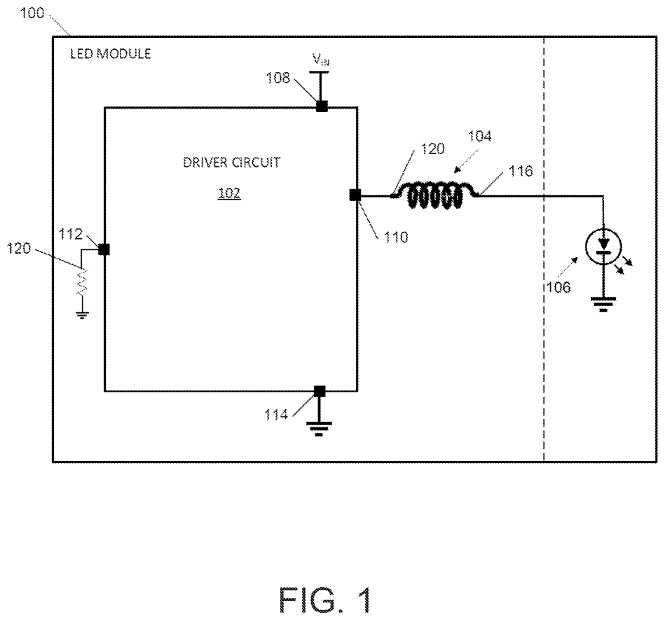

FIG. 1 shows a block diagram of a LED module 100 in accordance with at least some embodiments. In particular, FIG. 1 shows the example LED module 100 comprises a driver circuit 102, an inductor 104, and a LED 106. In some situations, the LED module 100 is a single integrated component (e.g., all devices disposed on one underlying circuit board), but in other situations the LED 106 may be disposed on its own underlying structure (e.g., a bulb assembly) apart from a driver circuit 102 and inductor 104, as shown by the dashed line in the figure.

The driver circuit 102 comprises an input-voltage terminal 108, a switch-node terminal 110, an average-current terminal 112, and a ground-reference terminal 114. Additional terminals may be present (e.g., enable terminal, serial-communication terminal, fault terminal), but the additional terminals are omitted so as not to unduly complicate the figure. The input-voltage terminal 108 couples to an input voltage V_{IN}. The input voltage V_{IN} may be supplied from a battery, such as the battery of an automobile, or the input voltage V_{IN} may be supplied from an upstream power converter. The ground-reference terminal 114 couples to a ground reference. The average-current terminal 112 is coupled to a resistor 120, and the resistor 120 is coupled to the ground reference. In the example system, the resistance of the resistor 120 sets or is proportional to a setpoint average current for the LED 106. In other cases, however, the setpoint average current may be communicated to the driver circuit 102 in other forms, such as by way of serial communications.

The inductor 104 defines a first lead 116 coupled to an anode of the LED 106, and a second lead 118 defining a switch node and thus coupled to the switch-node terminal 110. In the example system, a single LED 106 is shown, having an anode coupled to the first lead 116 and a cathode coupled to the ground reference. However, an array of LEDs may be present on the LED module. When an array of LEDs is present, the LEDs may be connected in series, in parallel, and/or a plurality of series-connected LEDs connected in parallel.

In accordance with example embodiments, when enable (e.g., by providing the input voltage V_{IN}) the driver circuit 102 and the inductor 104 create a drive voltage applied to the anode of the LED 106. More particularly, the driver circuit 102 and inductor 104 create a time-varying drive voltage that defines a saw tooth waveform or saw tooth pattern. During periods of time when the drive voltage is rising as part of the saw tooth pattern, current through the LED 106 is rising. During periods of time when the drive voltage is falling as part of the saw tooth pattern, current through the LED 106 is falling. However, the average current driven through the LED 106 (considering both the rising and falling currents over a plurality of cycles) is controlled to a setpoint average current. In example cases, and as shown, the setpoint average current is set or fixed by the resistor 120.

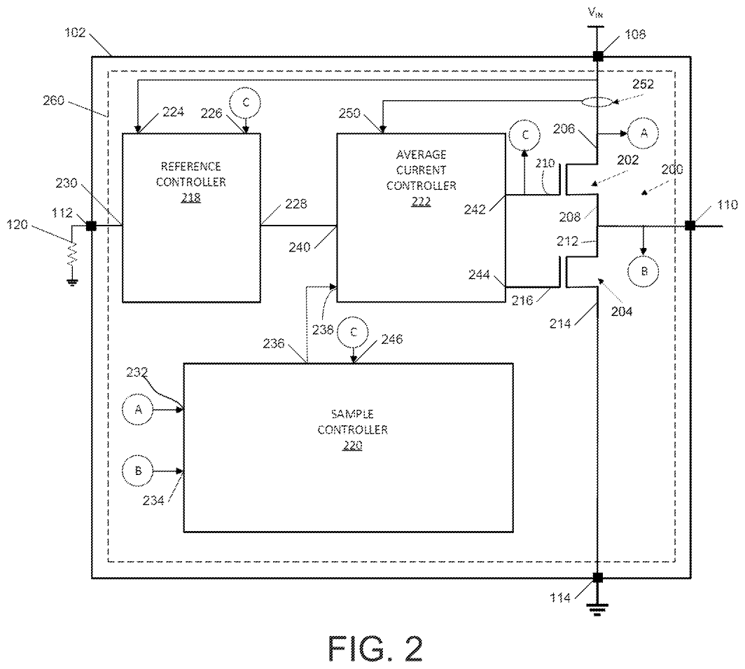

FIG. 2 shows a block diagram of an example driver circuit 102. FIG. 2 shows that the driver circuit 102 may comprise one or more substrates of semiconductor material (e.g., silicon), such as substrate 260, encapsulated within the packaging. Bond pads or other connection points of the substrate 260 couple to electrical terminals of the driver circuit 102 (e.g., terminals 108, 112, and 114). While a single substrate 260 is shown, in other cases multiple substrates may be combined to form the driver circuit 102 (e.g., a multi-chip module), and thus showing a single substrate 160 shall not be construed as a limitation.

The example driver circuit 102 comprises a set of power transistors 200 including a high-side field effect transistor 202 (high-side FET 202) and a low-side FET 204. The high-side FET 202 defines a current input 206 coupled to the input-voltage terminal 108, a current output 208 coupled to the switch-node terminal 110, and a control input 210. In one example case, the high-side FET 202 is N-channel metal-oxide semiconductor FET (MOSFET), and thus the current input 206 is the drain, and the current output 208 is the source, and the control input 210 is the gate. The low-side FET 204 defines a current output 212 coupled to the switch-node terminal 110, a current input 214 coupled to the ground-reference terminal 114, and a control input 216. In one example case, the low-side FET 204 is also an N-channel MOSFET, and thus the current output 212 is the drain, and the current input 214 is the source, and the control input 210 is the gate.

The example driver circuit 102 further comprises a reference controller 218, a sample controller 220, and an average current controller 222. The reference controller 218 defines a voltage input 224 coupled to the input-voltage terminal 108, sample-trigger input 226 coupled to the control input 210 of the high-side FET 202, a sample output 228, and a setpoint output 230 coupled to the average-current terminal 112. The reference controller 218 is designed and constructed to sense a drain-to-source voltage of a sense FET carrying a current set by the resistor 120, the current proportional to the setpoint average current of the example LED 106 (FIG. 1). The sensed drain-to-source voltage is provided on the sample output 228 to the average current controller 222.

Still referring to FIG. 2, the example driver circuit 102 further comprises the sample controller 220. The example sample controller 220 defines a sense input 232 illustratively coupled to the input-voltage terminal 108 and thus the current input 206 of the high-side FET 202, a sense input 234 coupled to the switch-node terminal 110, a sense output 236, and a gate input 246. The example sample controller 220 is designed and constructed to sense or sample a drain-to-source voltage of one of the power transistors of the set of power transistors 200. In the example driver circuit 102 of FIG. 2, the sample controller 220 is set up to sense the drain-to-source voltage of the high-side FET 202 by way of the sense inputs 232 and 234. In other cases, the sample controller 220 may sense the drain-to-source voltage of the low-side FET 204, in which case the sense input 232 and its electrical connection may be omitted. The drain-to-source voltage of the power transistor of the set of power transistors 200 is sampled at a point in time at which the current through the inductor 104 and/or the LED 106 (both FIG. 1) should be at the setpoint average current, hereafter the sample point. The sample point at which the drain-to-source voltage is sampled is discussed in greater detail below, but as a preview the sample point is determined based on integrating a voltage at the switch-node terminal 110. The integration creates a saw tooth waveform that emulates current through the inductor 104 and/or LED 106, and the saw tooth waveform has an average value. The sample point is determined or triggered by the emulated saw tooth waveform crossing the average value. The sampled drain-to-source voltage is applied to the sense output 236.

The example driver circuit 102 further comprises the average current controller 222. The average current controller 222 defines a feedback input 238 coupled to the sense output 236 of the sample controller 220, setpoint input 240 coupled to the sample output 228 of the reference controller 218, a high-gate output 242 coupled to the control input 210 of the high-side FET, and a low-gate output 244 coupled to the control input 216 of the low-side FET 204. In embodiments in which the average current controller 222 implements current mode control, the average current controller 222 may further comprise a current-sense input 250 coupled to a current sensor 252. The current sensor 252 is disposed between the input-voltage terminal 108 and the current input 206 of the high-side FET 202. The current sensor 252 may take any suitable form, such as a current transformer, small series resistor, or a Hall-effect sensor configured to drive a sense signal having an electrical property (e.g., magnitude of the voltage) proportional to the magnitude of the current flowing from the input-voltage terminal 108 to the control input 210 of the high-side FET 202.

In accordance with example embodiments, the average current controller 222 is designed and constructed to create an error signal based on a difference between a setpoint drain-to-source voltage (received from the reference controller 218 by way of the sample output 228) and the sampled drain-to-source voltage (received from the sample controller 220 by way of the feedback input 238). Based on the error signal created, the average current controller 222 is further designed and constructed to drive the low-side FET 204 to a non-conductive state and drive the high-side FET 202 to a conductive state for an on-time. The on-time is the period of time within a switching period in which the input voltage V_{IN} is coupled to the inductor 104 through the high-side FET 202. Because current through an inductor cannot change instantaneously, the current through the inductor builds over time while energy is stored in the field of the inductor. Thus, the on-time may be equivalently referred to as the charge mode of the inductor 104. After the charge mode completes (e.g., based on the inductor current reaching a predetermined peak current), the example average current controller 222 drives the high-side FET 202 to a non-conductive state and drives the low-side FET 204 to a conductive state for an off-time. The off-time is the period of time within the switching period in which the switch-node terminal 110 is coupled to the ground-reference terminal 114 by way of the low-side FET 204. Again because current through an inductor cannot change instantaneously, the current through the inductor continues to flow but falls over time as the field of the inductor collapses. Thus, the off-time may be equivalently referred to as the discharge mode of the inductor 104. It follows that current is driven to the LED 106 in both the charge mode and the discharge mode. The specification now turns to a description of the reference controller 218 in greater detail.

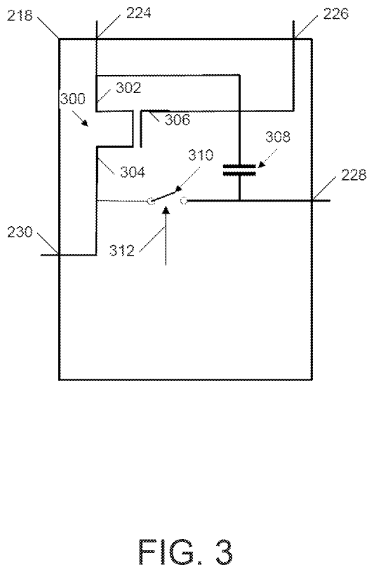

FIG. 3 shows a circuit diagram of an example reference controller 218. In particular, the reference controller 218 comprises a sense FET 300 defining a current input 302 coupled to the voltage input 224, a current output 304 coupled to the setpoint output 230, and a control input 306 coupled to the sample-trigger input 226. In one example case, the sense FET 300 is N-channel MOSFET, and thus the current input 302 is the drain, and the current output 304 is the source, and the control input 306 is the gate.

The reference controller 218 further comprises a sense capacitor 308 having a first lead coupled to the current input 302 of the sense FET 300, and a second lead coupled to the sample output 228. The example reference controller 218 also comprises an electrically-controlled switch 310 (hereafter just switch 310) illustratively shown as a single-pole, single-throw mechanical switch. However, any electrically-controlled switch may be used (e.g., FET, junction transistor). The switch 310 defines a first connection coupled to the setpoint output 230, a second connection coupled to the sample output 228, and a control input 312. When the control input 312 is asserted, the switch 310 is closed or conductive and couples the sense capacitor 308 across the sense FET 300, and thus the sense capacitor 308 is charged with the drain-to-source voltage of the sense FET 300. When the control input 312 of the switch 310 is de-asserted, the switch 310 is open or non-conductive, and thus the sense capacitor 308 holds the last drain-to-source voltage sensed.

Referring simultaneously to FIGS. 2 and 3. In practice, the resistor 120 is selected to create a setpoint current through the sense FET 300, where the current is proportional to the setpoint average current for the LED 106. Thus, during periods of time when the control input 306 of the sense FET 300 is asserted, the setpoint current flows through the sense FET 300, creating a drain-to-source voltage that charges the sense capacitor 308. In the example system shown, the control input 306 of the sense FET 300 is coupled to the control input 210 of the high-side FET 202, and thus when the high-side FET 202 is conductive so too is the sense FET 300. It follows that the control input 312 of the switch 310 in the example case is asserted contemporaneously with the conduction time of the high-side FET 202 (e.g., conductive for at least a portion of the on-time), and de-asserted when the low-side FET 204 is conductive such that the sense capacitor 308 holds the drain-to-source voltage representative of the setpoint average current. Stated otherwise, the sense capacitor 308 holds a setpoint drain-to-source voltage.

In an alternative arrangement, the control input 306 of the sense FET may be coupled to the control input 216 of the low-side FET 204. In the alternative arrangement, the control input 312 of the switch 310 is asserted contemporaneously with the conduction time of the low-side FET 204 (e.g., conductive for at least a portion of the discharge mode), and de-asserted when the high-side FET 202 is conductive. Either way, the drain-to-source voltage developed across the sense FET 300 is proportional to the setpoint average current. Stated otherwise, the sense capacitor 308 holds a setpoint drain-to-source voltage or a voltage proportional to the setpoint drain-to-source voltage. An

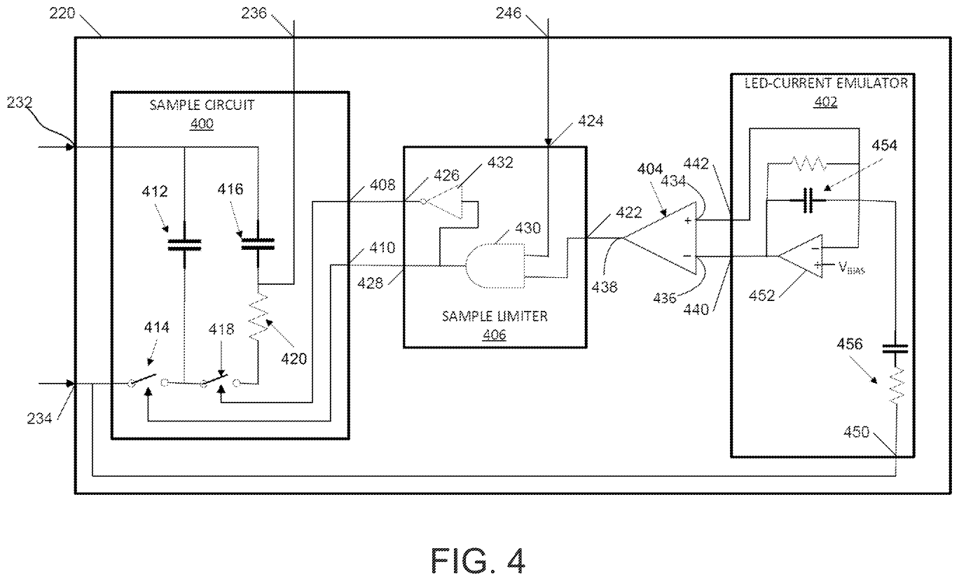

FIG. 4 shows a block diagram of an example sample controller 220. In particular, the example sample controller 220 comprises a sample circuit 400, an LED-current emulator 402, a comparator 404, and a sample limiter 406. The example sample circuit 400 is coupled to the sense input 232 (and thus the input-voltage terminal 108), the sense input 234 (and thus the switch-node terminal 110), and the sense output 236. The sample circuit 400 further defines a hold input 408 and a sample input 410. In accordance with various embodiments, the sample circuit 400 is designed and constructed to measure a drain-to-source voltage of a power transistor of the set of power transistors 200. The example sample circuit 400 is set up to measure the drain-to-source voltage of the high-side FET 202 during the charge mode of the inductor, but in other cases (discussed more below) the sample circuit 400 may be set up to measure the drain-to-source voltage of the low-side FET 204 during the discharge mode.

The example sample circuit 400 comprises a sample capacitor 412 having a first lead coupled to the sense input 232 and a second lead. An electrically-controlled switch 414 (hereafter just switch 414) has a first connection coupled to the sense input 234, a second connection coupled to the second lead of the sense capacitor 412, and a control input coupled to the sample input 410. The sample circuit 400 further comprises a hold capacitor 416 having a first lead coupled to the sense input 232 and a second lead coupled to the sense output 236. An electrically-controlled switch 418 (hereafter just switch 418) has a first connection coupled to the second lead of the sample capacitor 414, a second connection, and a control input coupled to the hold input 408. A resistor 420 is coupled between the second connection of the switch 418 and the second lead of the hold capacitor 416.

During periods when the sample input 410 is asserted and the hold input 408 is de-asserted, the switch 414 is closed or conductive and the switch 418 is open or non-conductive. Thus, in the example arrangement, the drain-to-source voltage of high-side FET 202 is sampled by the sample capacitor 412. During periods when the sample input 410 is de-asserted and the hold input 408 is asserted, the switch 414 is open or non-conductive and the switch 418 is closed or conductive. Thus, during the example second period the drain-to-source voltage held on the sample capacitor 412 is transferred (through resistor 420) to the hold capacitor 416. It follows that at all times there is a sampled drain-to-source voltage applied to the sense output 236, and that sampled drain-to-source voltage is updated once each switching period in the example embodiments.

Still referring to FIG. 4, the sample controller 220 further comprises the sample limiter 406. The sample limiter 406 defines a sample input 422, a timing input 424 coupled to the gate input 246, a hold output 426 coupled to the hold input 408, and a sample output 428 coupled to the sample input 410. The sample limiter 406 is designed and constructed to assert the sample output 428 once in each switching period of the driver circuit 102. More particularly, and as will be described in greater detail below, the sample input 422 may be asserted twice in each switching period: once during the charge mode when the emulated LED current crosses the average value; and once during the discharge mode when the emulated LED current again crosses the average value. Responsive to assertion of the sample input 422, the sample limiter 406 asserts the sample output 428 (and de-asserts the hold output 426) only once during the switching period. In cases in which the timing input 424 is coupled to the gate of the high-side FET 202 (as shown in FIG. 2), the sample limiter 406 asserts the sample output 428 (and de-asserts the hold output 426) during the charge mode beginning when the emulated LED current rises through the average value, and ending at the end of the charge mode.

FIG. 4 further shows example logic gates to implement the functionality of the sample limiter 406. In particular, the sample limiter 406 further comprises an AND gate 430 defining a first input coupled to the timing input 424, a second input coupled to the sample input 422, and a gate output coupled to and defining the sample output 428. The example sample limiter 406 further comprises a NOT gate 432 defining input coupled to the sample output 428, and inverted output coupled to and defining the hold output 426.

The comparator 404 defines a compare output 438 coupled to the sample input 422, a non-inverting input 434, and an inverting input 436. The LED-current emulator drives a saw tooth waveform to the emulator output 440 coupled to the inverting input 436 of the comparator 404. The LED-current emulator 402 further drives a signal indicative of average value to the average output 442 coupled to the non-inverting input 434 of the comparator 404. It follows that compare output 438 changes state when the emulated saw tooth waveform crosses the signal indicative of average value.

The driver circuit 102 further comprises the LED-current emulator 402. LED-current emulator 402 defines the emulator output 440 and the average output 442. The example LED-current emulator 402 also defines a switch-node input 450 coupled to the sense input 234 and thus the switch-node terminal 110. The LED-current emulator 402 is designed and constructed to integrate a voltage on the switch-node terminal and drive, to the emulator output 440, a saw tooth waveform having an average value. More particularly, the voltage at the switch-node terminal 110 cycles between the input voltage V_{IN} (during the charge mode) and the ground reference (during the discharge mode). However, the current through the inductor 104 is proportional to the amount of time the input voltage V_{IN} is coupled to the inductor 104 during the charge mode, and further the current through the inductor 104 is proportional to the amount of time the ground reference is coupled to the inductor 104 during the discharge mode. The example LED-current emulator 402 creates an emulated inductor current by integrating over time the voltage on the switch-node terminal 110. The integration results in a saw tooth waveform having an average value. The example LED-current emulator 402 provides the saw tooth waveform to the emulator output 440, and provides the average value of the saw tooth waveform to the average output 442. So long as the peak values of the saw tooth waveform are within the operating range of the comparator 404, the actual peak values may be selected at the discretion of the circuit designer. Similarly, so long as the voltage indicative of the average value is within the operating range of the comparator 404, the voltage used to be indicative of the average value again may be selected at the discretion of the circuit designer. The LED-current emulator 402 works with the comparator 404 to delineate the point in time when the emulated saw tooth waveform crosses the voltage indicative of the average value. In steady-state operation of the LED module 100 driving the LED 106 (FIG. 1), the point in time when the emulated saw tooth waveform crosses the voltage indicative of the average value should corresponding to the current through the inductor 104 and LED 106 crossing the setpoint average current. As will be discussed in greater detail below, if the actual current through the inductor 104 and LED is higher or lower than the setpoint average current (as sampled in the reference controller 218), then the average current controller 222 (FIG. 2) takes control action (e.g., increasing the on-time or decreasing the on-time).

Still referring to FIG. 4, the example LED-current emulator 402 comprises an operational amplifier 452 configured for integration, as shown by the capacitor 454 coupled between the inverting input and the integrated output of the operational amplifier 452. In particular, the voltage of the switch-node terminal 110 (applied through the switch-node input 450) is coupled to the inverting input of the operational amplifier 452 by way of a filter network 456. The voltage at the switch-node input 450 may be optionally scaled down by a voltage divider (not specifically shown). The integrated output of the operational amplifier 452 is coupled to and defines the emulator output 440. The non-inverting input of the operational amplifier 452 is coupled to a bias voltage V_{BIAS}. So long as bias voltage V_{BIAS} is within the operation range of the operational amplifier 452, the voltage may be selected at the discretion of the circuit designer. It turns out that the bias voltage V_{BIAS} will be the average value of the integration performed by the operational amplifier 452 in conjunction with the capacitor 454. Thus, in the example embodiment shown the inverting input of the operational amplifier 452 (which very closes matches the bias voltage V_{BIAS}) is coupled to the average output 442 to be provided to the comparator 404.

Returning briefly again to comparator 404, the comparator 404 is provided, by way of the emulator output 440, the emulated saw tooth waveform created by the operational amplifier 452. The comparator 404 is also provided, by way of the average output 442, a voltage indicative of the average value of the emulated saw tooth waveform. As described above, the comparator output 438 thus changes state each time the saw tooth waveform applied to the non-inverting input 436 crosses the voltage indicative the average value of the saw tooth waveform applied to the non-inverting input 434.

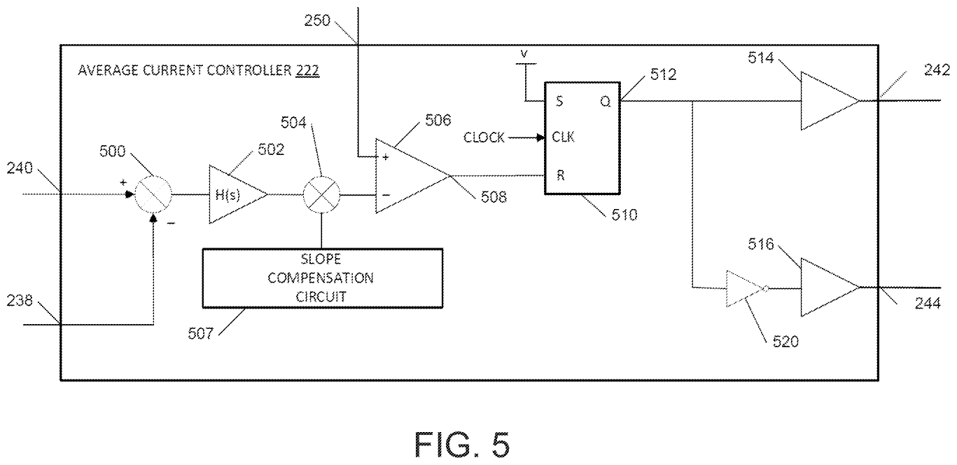

FIG. 5 shows a block diagram of an example average current controller 222. In particular, the average current controller 222 comprises the feedback input 238, the setpoint input 240, the current-sense input 250, the high-gate output 242, and the low gate output 244. The average current controller 222 is designed and constructed to create an error signal based on a difference between a setpoint drain-to-source voltage (received on the setpoint input 240) and the sampled drain-to-source voltage (received on the feedback input 238). Based on the error signal, the average current controller 222 de-asserts the low-gate output 244 (making the low-side FET non-conductive) and asserts the high-gate output 242 (making the high-side FET conductive) for a charge mode. After the on-time of the charge mode, the average current controller 222 de-assets the high-gate output 242 (making high-side FET non-conductive) and asserts the low-gate output 244 (making the low-side FET conductive) a discharge mode. In example cases, the on-time of the charge mode is based on the error signal, with longer on-times of charge mode when the error signal indicates the average current through the inductor and LED is low, and shorter on-times of the charge mode when the average current through the inductor and LED is high.

FIG. 5 further shows example internal components of the average current controller 222. In particular, in the example arrangement a summation block 500 defines a first input coupled to the setpoint input 240 and a second input coupled to the feedback input 238. The example summation block 500 subtracts a feedback signal supplied by way of the feedback input 238 from a setpoint signal supplied by way of the setpoint input 240. In the example system, the setpoint signal is a sampled drain-to-source voltage of the sense FET 300 of the reference controller 218. That is, the sampled drain-to-source voltage is proportional to a drain-to-source voltage of one of the power FETs when the power FET is carrying the setpoint average current through the LED 106. The feedback signal is a sampled drain-to-source voltage of one of the power FETs at a moment in time when current through the power FET should be crossing setpoint average current through the LED 106. If the feedback signal is different than the setpoint signal, a non-zero error voltage is produced on a summation output of the summation block 500.

The error signal produced at the error output of the summation block 500 is coupled to an amplifier system 502. In example cases, the amplifier system 502 implements a transfer function H(S), such as a proportional-integral-differential (PID) control (e.g., a Type III Compensation Network) using the error signal supplied from the summation block 500. A control signal generated by the amplifier system 502 is applied to another summation block 504, where the control signal is combined with a slope compensation signal produced by the slope compensation circuit 507. In the example system, the compensated signal produced on the compensation output of the summation block 504 is proportional to a peak current to be reached in each charge mode.

The example average current controller 222 further comprises a comparator 506 defining an inverting input coupled to the compensation output of the summation block 504, a non-inverting coupled to the current-sense input 250, and a reset output 508. The comparator 506 thus compares a signal indicative of current received on the current-sense input 250 to the compensation signal, and asserts the reset output 508 when the signal indicative of current crosses the compensation signal (e.g., when the current through the high-side FET and inductor reach the peak current value represented by the compensated signal).

Still referring to FIG. 5, the example average current controller 222 further includes a SR latch 510 that defines a set input coupled to an asserted signal (e.g., voltage on a power rail), a reset input coupled to the reset output 508 of the comparator 506, a clock input (CLK) coupled to a clock signal, and a latch output 512. In the example system, a clock signal applied to the clock input CLK sets the start time of each charge mode. That is, with the set input held high, with each asserted state of the clock signal (e.g. each rising edge) applied to the clock input CLK, the latch output 512 is asserted. The latch output 512 remains asserted until the reset input is asserted by the comparator 506. Stated otherwise, the latch output 512 remains asserted until the current through the high-side FET, the inductor, and the LED reaches the peak current value represented by the compensated signal. The latch output 512 remains de-asserted until the next asserted state of the clock signal applied to the clock input CLK.

The example average current controller 222 further comprises a gate driver amplifier 514 having a drive input coupled to the latch output 512, and a drive output coupled to and defining the high-gate output 242. The gate driver amplifier 514 is designed and constructed to, responsive to assertion of the latch output 512, drive a current and voltage to the gate of the high-side FET sufficient to make the high-side FET fully conductive. Similarly, the example average current controller 222 comprises a gate driver amplifier 516 having a drive input coupled to the latch output 512 by way of a NOT gate 518, and a drive output coupled to and defining the low-gate output 244. The gate driver amplifier 516 is likewise designed and constructed to, responsive to de-assertion of the latch output 512, drive a current and voltage to the gate of the low-side FET sufficient to make the high-side FET fully conductive.

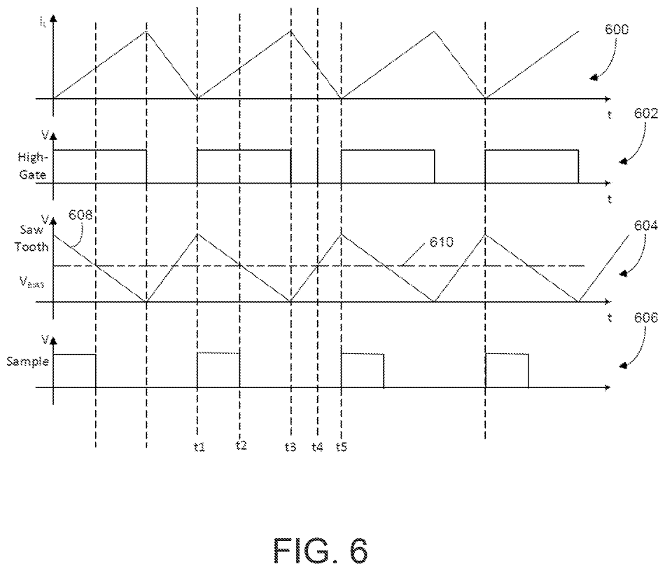

FIG. 6 shows a timing diagram in accordance with at least some embodiments. In particular, FIG. 6 includes: plot 600 showing inductor current I_{L} as a function time; plot 602 showing the voltage applied to the control input of the high-side FET as a function of time; plot 604 showing an emulated saw tooth waveform as a function of time, and a co-plotted bias voltage V_{BIAS}; and plot 606 showing a sample signal applied to the sample circuit 400 as a function of time. The plots are along corresponding time axes.

In particular, FIG. 6 shows three complete and one partial switching periods for the example LED module 100 (FIG. 1). Plot 600, for example, shows an example charge mode between times t1 and t3, and an example discharge mode between times t3 and t5. During the charge mode, the inductor current inductor current I_{L} rises from a low value to a peak value (e.g., the peak value set by the average current controller). During the discharge mode current falls from the peak value until the next charge mode begins. Stated otherwise, the time period between times t1 and t3 is an example on-time of the charge mode, and the time period between times t3 and t5 is an example off-time of the discharge mode.

Plot 602 shows an example signal provided to the control input 210 of the high-side FET 202. The control input 216 of the low-side FET 204 receives a signal that is a logical NOT of the signal of plot 602 (see, e.g., the NOT gate 520 of FIG. 5). Thus, the example signal is shown asserted (e.g., asserted high) between times t1 and t3, and de-asserted between times t3 and t5. During times when the control input 210 of the high-side FET 202 is asserted, the high-side FET 202 is conductive. During times when the control input 210 of the high-side FET 202 is de-asserted, the high-side FET 202 is non-conductive.

Plot 604 shows, as signal 608, an example emulated saw tooth waveform created by the LED-current emulator 402 (hereafter the emulated saw tooth waveform 608). For convenience of the circuit design, the magnitude of the emulated saw tooth waveform 608 is a mirror image of the magnitude of the inductor current I_{L}, but with the benefit of this disclosure one of ordinary skill could create an emulated saw tooth waveform polarity changes that match the inductor current I_{L}. As discussed above, however, it is the points in time when the emulated saw tooth waveform 608 crosses the average value that is the trigger to sample the drain-to-source voltage of one of the power transistors of the set of power transistors 200. Co-plotted with the emulated saw tooth waveform 608 is the bias voltage V_{BIAS} 610 that represents the average current with respect to the emulated saw tooth waveform 608. Considering the switching period between times t1 and t5, the emulated saw tooth waveform 608 crosses (e.g., falls below) the bias voltage V_{BIAS} 610 at time t2, and the emulated saw tooth waveform 608 again crosses (e.g., rises above) the bias voltage V_{BIAS} 610 at time t4.

Plot 606 shows an example sample signal as applied to the sample input 410 of the sample circuit 400. The hold input 408 of the sample circuit 400 receives a hold signal that is a logical NOT of the sample signal (see, e.g., NOT gate 432). Thus, in embodiments in which the drain-to-source voltage of the high-side FET 202 is sampled as part of the control methodology, the sample signal is asserted (e.g., asserted high) between times t1 and t2. At time t2, the example sample signal is de-asserted (and the hold signal is asserted), and thus the sample circuit holds the sampled drain-to-source voltage across hold capacitor 416. In other example arrangements, the sample controller 220, and thus the sample circuit 400, may be designed and constructed to sample the drain-to-source voltage of the low-side FET 204. In such alternate arrangements, the sample signal would be designed and constructed to be asserted between times t3 and t4, such that the sampled drain-to-source voltage at the state transition at time t4 becomes the feedback signal applied to the feedback input 233 of the average current controller.

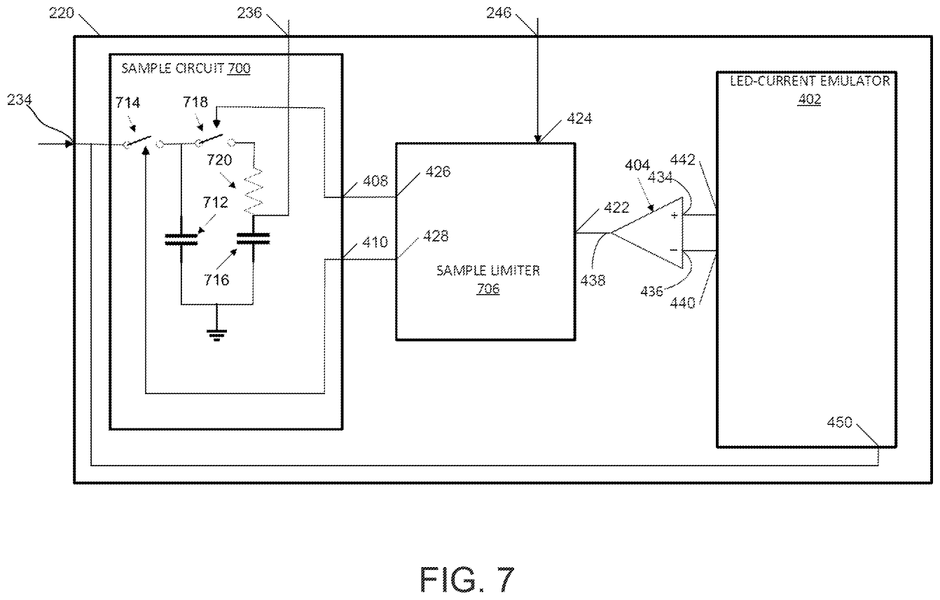

FIG. 7 shows a block diagram of an example sample controller 220 in accordance with other example embodiments. In particular, the example sample controller 220 comprises a sample circuit 700, the LED-current emulator 402, the comparator 404, and a sample limiter 706. The LED-current emulator 402 and comparator 404 may be the same as previously discussed, and thus the operation and internal components are not reproduced again so as not to further complicate the figure.

The example sample circuit 700 is coupled to the sense input 234 (and thus the switch-node terminal 110) and the sense output 236. The sample circuit 700 further defines the hold input 408 and the sample input 410. In accordance with various embodiments, the sample circuit 700 is designed and constructed to measure a drain-to-source voltage of the low-side FET 204 during the discharge mode of the inductor, and thus only the connection to the switch-node terminal 110 is used (at the sense input 234). The connection to the input-voltage terminal 108 may be omitted when sampling the drain-to-source voltage of the low-side FET 204.

The example sample circuit 700 comprises a sample capacitor 712 having a second lead coupled to the ground reference and a first lead. An electrically-controlled switch 714 (hereafter just switch 714) has a first connection coupled to the sense input 234, a second connection coupled to the first lead of the sample capacitor 712, and a control input coupled to the sample input 410. The sample circuit 700 further comprises a hold capacitor 716 having a second lead coupled to the ground reference, and a first lead. An electrically-controlled switch 718 (hereafter just switch 718) has a first connection coupled to the first lead of the sample capacitor 712, a second connection, and a control input coupled to the hold input 408. A resistor 720 is coupled between the second connection of the switch 718 and the first lead of the hold capacitor 716.

During periods when the sample input 410 is asserted and the hold input 408 is de-asserted, the switch 714 is closed or conductive and the switch 718 is open or non-conductive. Thus, in the example arrangement, the drain-to-source voltage of low-side FET 204 is sampled by the sample capacitor 712. During periods when the sample input 410 is de-asserted and the hold input 408 is asserted, the switch 714 is open or non-conductive and the switch 718 is closed or conductive. Thus, during the example second period the drain-to-source voltage held on the sample capacitor 712 is transferred (through resistor 720) to the hold capacitor 716. It follows that at all times there is a sampled drain-to-source voltage applied to the sense output 236, and that sampled drain-to-source voltage is updated once each switching period in the example embodiments.

FIG. 7 further shows sample limiter 706. In the arrangement in which the sampled drain-to-source voltage is created with reference to the low-side FET 204, the gate input 246 and timing input 424 of the sample limiter 706 are coupled to the control input 216 of the low-side FET 204 rather than the control input of the high-side FET 202. Thus, the sample limiter 406 asserts the sample output 428 (and de-asserts the hold output 426) during the discharge mode beginning when the when the emulated LED current falls through the average value, and ending at the end of the discharge mode. One of ordinary skill, with the benefit of this disclosure, could design a set of logic gates to create the sample and hold signals for the sample limiter 706 (e.g., using the same gates as sample limiter 406, with an additional NOT gate between the sample input 422 and the AND gate).

The remaining components of the sample controller 220 are as discussed above, and thus the explanation will not be repeated here so as not to unduly lengthen the specification.

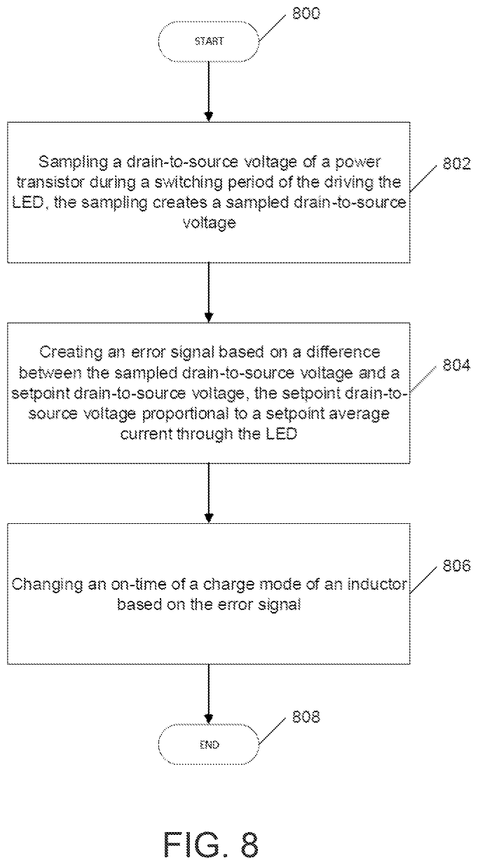

FIG. 8 shows a method in accordance with at least some embodiments. In particular, the method starts (block 800) and comprises: sampling a drain-to-source voltage of a power transistor during a switching period of the driving the LED, the sampling creates a sampled drain-to-source voltage (block 802); creating an error signal based on a difference between the sampled drain-to-source voltage and a setpoint drain-to-source voltage, the setpoint drain-to-source voltage proportional to a setpoint average current through the LED (block 804); and changing an on-time of a charge mode of an inductor based on the error signal (block 806). Thereafter the method ends (block 808), likely to be restarted in the next switching period.

Many of the electrical connections in the drawings are shown as direct couplings having no intervening devices, but not expressly stated as such in the description above. Nevertheless, this paragraph shall serve as antecedent basis in the claims for referencing any electrical connection as “directly coupled” for electrical connections shown in the drawing with no intervening device(s).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method of driving a light emitting diode (LED), the method comprising:
sampling a drain-to-source voltage of a power transistor during a switching period of the driving the LED, the sampling creates a sampled drain-to-source voltage;
creating an error signal based on a difference between the sampled drain-to-source voltage and a setpoint drain-to-source voltage, the setpoint drain-to-source voltage proportional to a setpoint average current through the LED; and
changing an on-time of a charge mode of an inductor based on the error signal.

2. The method of claim 1 wherein sampling the drain-to-source voltage further comprise:
integrating a voltage at a switch node, the integrating creates a saw tooth waveform having an average value; and
triggering the sampling of the drain-to-source voltage when the saw tooth waveform crosses the average value.

3. The method of claim 1 wherein sampling the drain-to-source voltage further comprises sampling as current through the inductor is rising during the charge mode of the inductor.

4. The method of claim 1 wherein sampling the drain-to-source voltage further comprises sampling as current through the inductor is falling during a discharge mode of the inductor.

5. The method of claim 1 wherein sampling the drain-to-source voltage further comprises sampling the drain-to-source voltage of a high-side transistor coupled between an input voltage and the switch node.

6. The method of claim 1 wherein sampling the drain-to-source voltage further comprises sampling the drain-to-source voltage of a low-side transistor coupled between the switch node and a ground reference.

7. The method of claim 1 further comprising:
driving a setpoint current through a sense transistor; and
sampling the drain-to-source voltage of the sense transistor to create the setpoint drain-to-source voltage.

8. The method of claim 1 wherein changing the on-time of the charge mode further comprises changing a peak current setpoint at which the charge mode ends.

9. A driver circuit for driving a light emitting diode (LED), the driver circuit comprising:
an input-voltage terminal, a switch-node terminal, an average-current terminal, and a ground-reference terminal;
a set of power transistors comprising a high-side field effect transistor (high-side FET) coupled between the input-voltage terminal and the switch-node terminal, and a low-side FET coupled between the switch-node terminal and the ground-reference terminal;
a reference controller coupled to the input-voltage terminal and the average-current terminal, the reference controller configured to drive, on a setpoint output, a setpoint drain-to-source voltage proportional to a setpoint average current through the LED;
a sample controller coupled to the switch-node terminal, the sample controller configured to drive, on a sampled output, a sampled drain-to-source voltage of a power transistor of the set of power transistors;
an average current controller coupled to the setpoint output, the sampled output, and control inputs of the set of power transistors, the average current controller configured to:
create an error signal based on a difference between the setpoint drain-to-source voltage and the sampled drain-to-source voltage;
drive the low-side FET to a non-conductive state and drive the high-side FET to a conductive state for an on-time, the on-time based on the error signal; and then
drive the high-side FET to a non-conductive state and drive the low-side FET to a conductive state for an off-time.

10. The driver circuit of claim 9 wherein the sample controller further comprises:
a sample circuit configured to measure a drain-to-source voltage of the power transistor of the set of power transistors;
an LED-current emulator coupled to the switch-node terminal and configured to drive, to an emulator output, a saw tooth waveform having an average value;
a comparator having a first input coupled to the emulator output, a second input coupled to a reference voltage, and a comparator output; and
a sample limiter defining a sample input coupled to the comparator output, a timing input coupled to a control input of the power transistor of the set of power transistors, and a sample output coupled to the sample controller, the sample limiter configured to assert the sample output once in each switching period of the driver circuit.

11. The driver circuit of claim 9 wherein the sample controller further comprises:
a sample circuit configured to measure a drain-to-source voltage of the high-side FET, the high-side FET coupled between the input-voltage terminal and the switch-node terminal;
an LED-current emulator configured to integrate a voltage on the switch-node terminal and drive, to an emulator output, a saw tooth waveform having an average value;
a comparator having a first input coupled to the emulator output, a second input coupled to a reference voltage, and a comparator output; and
a sample limiter defining a sample input coupled to the comparator output, a timing input coupled to a control input of the power transistor of the set of power transistors, and a sample output coupled to the sample controller, the sample limiter configured to assert the sample output once in each switching period of the driver circuit.

12. The driver circuit of claim 9 wherein the sample controller further comprises:
a sample circuit configured to measure a drain-to-source voltage of the low-side FET, the low-side FET coupled between the switch-node terminal and the ground-reference terminal;
an LED-current emulator configured to integrate a voltage on the switch-node terminal and drive, to an emulator output, a saw tooth waveform having an average value;
a comparator having a first input coupled to the emulator output, a second input coupled to a reference voltage, and a comparator output; and
a sample limiter defining a sample input coupled to the comparator output, a timing input coupled to a control input of the power transistor of the set of power transistors, and a sample output coupled to the sample controller, the sample limiter configured to assert the sample output once in each switching period of the driver circuit.

13. The driver circuit of claim 9 wherein the reference controller further comprises:
a sense FET defining a current input coupled to the input-voltage terminal, a current output coupled to the average-current terminal, and a control input;
an electrically-controlled switch having a first connection coupled to the average-current terminal, a second connection, and a control input;
a sense capacitor having a first lead coupled to the second connection of the electrically-controlled switch; and
the reference controller configured to sample a drain-to-source voltage of the sense FET during a sample period when the electrically-controlled switch is conductive, and configured to hold the drain-to-source voltage on the sense capacitor during a hold period when the electrically-controlled switch is non-conductive.

14. The driver circuit of claim 9 further comprising:
the high-side FET defining a current input coupled to the input-voltage terminal, a current output coupled to the switch-node terminal, and a control input coupled to the average current controller; and
the low-side FET defining a current input coupled to the ground-reference terminal, a current output coupled to the switch-node terminal, and a control input coupled to the average current controller.

15. The driver circuit of claim 9 wherein when the average current controller drives the low-side FET to the non-conductive state and drives the high-side FET to the conductive state, the average current controller is further configured to drive the low-side FET to the non-conductive state and drive the high-side FET to the conductive state until current through the high-side FET reaches a predetermined peak current.

16. A light emitting diode module comprising:
a light emitting diode (LED);
an inductor defining a first lead coupled to an anode of the LED, and a second lead defining a switch node;
a setpoint resistor defining a first lead coupled to a ground reference and a second lead, a resistance of the setpoint resistor is proportional a setpoint average current for the LED;
a driver circuit comprising:
a set of power transistors comprising a high-side field effect transistor (high-side FET) coupled between an input voltage and the second lead of the inductor, and a low-side FET coupled between the switch node and the ground reference;
a reference controller coupled to the input voltage the second lead of the setpoint resistor, the reference controller configured to drive, to a setpoint output, a setpoint voltage proportional to the setpoint average current through the LED;
a sample controller coupled to the switch node, the sample controller configured to drive, to a sampled output, a sampled drain-to-source voltage of a power transistor of the set of power transistors;
an average current controller coupled to the setpoint output, and to control inputs of the set of power transistors, the average current controller configured to:
create an error signal based on a difference between a setpoint drain-to-source voltage and the sampled drain-to-source voltage;
drive the low-side FET to a non-conductive state and drive the high-side FET to a conductive state for an on-time, the on-time based on the error signal; and then
drive the high-side FET to a non-conductive state and drive the low-side FET to a conductive state for an off-time.

17. The light emitting diode module of claim 16 wherein the sample controller further comprises:
a sample circuit configured to measure a drain-to-source voltage of the power transistor of the set of power transistors;
an LED-current emulator coupled to the switch node and configured to drive, to an emulator output, a saw tooth waveform having an average value;
a comparator having a first input coupled to the emulator output, a second input coupled to a reference voltage, and a comparator output; and
a sample limiter defining a sample input coupled to the comparator output, a timing input coupled to a control input of the power transistor of the set of power transistors, and a sample output coupled to the sample controller, the sample limiter configured to assert the sample output once in each switching period of the driver circuit.

18. The light emitting diode module of claim 16 wherein the sample controller further comprises:
a sample circuit configured to measure a drain-to-source voltage of the high-side FET, the high-side FET coupled between the input voltage and the switch node;
an LED-current emulator configured to integrate a voltage on the switch node and drive to, an emulator output, a saw tooth waveform having an average value;
a comparator having a first input coupled to the emulator output, a second input coupled to a reference voltage, and a comparator output; and
a sample limiter defining a sample input coupled to the comparator output, a timing input coupled to a control input of the power transistor of the set of power transistors, and a sample output coupled to the sample controller, the sample limiter configured to assert the sample output once in each switching period of the driver circuit.

19. The light emitting diode module of claim 16 wherein the sample controller further comprises:
a sample circuit configured to measure a drain-to-source voltage of the low-side FET, the low-side FET coupled between the switch node and the ground reference;
an LED-current emulator configured to integrate a voltage on the switch node and drive, to an emulator output, a saw tooth waveform having an average value;
a comparator having a first input coupled to the emulator output, a second input coupled to a reference voltage, and a comparator output;
a sample limiter defining a sample input coupled to the comparator output, a timing input coupled to a control input of the power transistor of the set of power transistors, and a sample output coupled to the sample controller, the sample limiter configured to assert the sample output once in each switching period of the driver circuit.

20. The light emitting diode module of claim 16 wherein the reference controller further comprises:
a sense FET defining a current input coupled to the input voltage, a current output coupled to the second lead of the setpoint resistor, and a control input;
an electrically-controlled switch having a first connection coupled to the second lead of the setpoint resistor, a second connection, and a control input;
a sense capacitor having a first lead coupled to the second connection of the electrically-controlled switch; and
the reference controller configured to sample a drain-to-source voltage of the sense FET during periods with the electrically-controlled switch is conductive, and configured to hold the drain-to-source voltage on the sense capacitor during periods when the electrically-controlled switch is non-conductive.
